(19) United States
(12) Patent Application Publication
(10) Pub. No.: US 2010/0023451 A1
(43) Pub. Date: Jan. 28, 2010

(54) Method of Online Payment Authorization, A Method of Correlating Text Messages and Systems Therefor

(75) Inventors: Joy Melanie Lambert, Wellington (NZ); Deborah Jane Crowe, Wellington (NZ); David Iain Ritchie, Wellington (NZ); Justin Jacob Boersma, Wellington (NZ)

Correspondence Address: KLEINBERG & LERNER, LLP, 1875 CENTURY PARK EAST, SUITE 1150, LOS ANGELES, CA, 90067, US

(73) Assignee: Run the Red Limited, Wellington (NZ)

(21) Appl. No.: 12/439,488

(22) PCT Filed: Aug. 29, 2007
(86) PCT No.: PCT/NZ07/00237

§ 371 Date: Aug. 21, 2009

(30) Foreign Application Priority Data
Sep. 1, 2006 (NZ) 549654

(51) Int. Cl. G06Q 20/00; G06F 15/16; G06F 21/00; H04L 9/32

(52) U.S. Cl. 705/40; 709/206; 726/7

(57) ABSTRACT

A method of correlating text messages by allocating a sending address to an outgoing text message, sending the outgoing text message to a recipient address from the sending address, receiving an incoming text message from the recipient address to the sending address and correlating the outgoing and incoming text messages based on the sending address and recipient address. The method may be used to automatically action payment or other instructions or to actuate a physical actuator. The sending address may be selected from a pool of codes, such as short codes.

### FIELD OF THE INVENTION

This invention relates to a method of effecting online payments using text messaging and a method of correlating text messages. Systems for effecting the methods are also disclosed.

### BACKGROUND OF THE INVENTION

It is now possible to make payments utilizing a range of online payment options such as internet banking etc. Consumers are increasingly demanding mobile services including mobile payment options. Some forms of online payment are possible using advanced mobile phones—for example payments may be made using internet banking using WAP enabled mobile phones. However, this solution is not possible for more basic mobile phones with only text messaging capabilities as there is no way of correlating outward and inward messages.

It would be desirable to provide a method enabling online payment to be effected using text messaging. In other applications it would be desirable to correlate outgoing and incoming text messages and optionally to initiate processing based on the content of a reply message.

It is an object of the invention to satisfy these needs or to at least provide the public with a useful choice.

### EXEMPLARY EMBODIMENTS

According to one exemplary embodiment there is provided a method of authorisation of a payment comprising:

allocating one of a plurality of sending addresses to a transaction;
sending a text message payment request to a recipient address from the sending address;
receiving a text message payment instruction from the recipient address to the sending address;
correlating the text message payment instruction with the text message payment request based on the sending address and recipient address: and
processing the payment instruction.

According to another exemplary embodiment there is provided an automated payment system comprising processing means for receiving payment requests, allocating a sending address to a payment request, sending the payment request in a text message to a recipient address from the sending address, receiving a text message payment instruction from the recipient address, reconciling the payment instruction with the payment request based on the sending address and the recipient address and processing the transaction based on the payment request and payment instruction.

According to a further exemplary embodiment there is provided a method of correlating text messages comprising:

allocating one of a plurality of sending addresses to an outgoing text message;
sending the outgoing text message to a recipient address from the sending address;
receiving an incoming text message from the recipient address to the sending address; and
correlating the outgoing and incoming text messages based on the sending address and recipient address.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows a schematic view of an online payment system; and

FIG. 2 illustrates the message flow and processing within the system for one embodiment.

### DETAILED DESCRIPTION OF EMBODIMENTS OF THE INVENTION

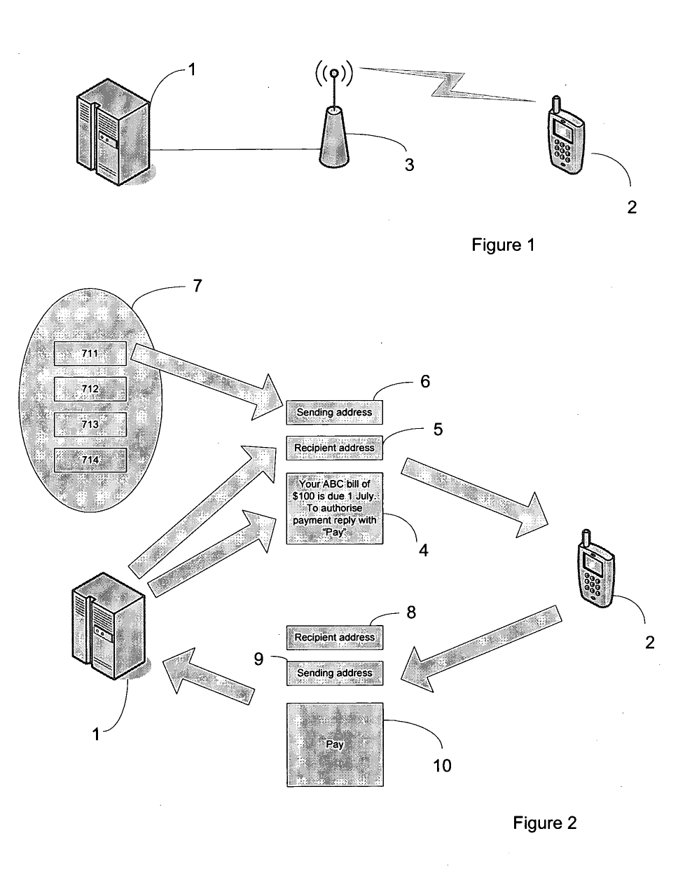

FIG. 1 shows schematically an online payment system in which a central computer 1 communicates with a mobile phone 2 via text messages conveyed by a telecommunications system 3. Computer 1 may be located at a bank or other financial institution and telecommunications system 3 may be operated by a telecommunications operator.

FIG. 2 shows the message flow for authorizing a payment. To generate a payment request computer 1 generates a payment request 4. This may be of any desired form but in this case includes the payee, amount to be paid, due date and payment instructions. The recipient address 5 is obtained from a database containing customer information. The sending address 6 (711 in this case) is obtained from a pool of sending numbers 7. The pool may be of a size appropriate for the nature of the transactions concerned. Once a sending address is selected for a customer transaction it may be removed from the pool of sending addresses for that customer until the transaction for the customer using that sending address is completed or the transaction expires. The pool of sending addresses 7 may be a pool of short codes, long codes or MISDN numbers, although any type of address may be used.

The payment request 4, recipient address 5 and sending address 6 are assembled and sent as a text message to the recipient address for the customer's mobile phone 2. The customer views the text message payment request 4 and can elect to authorize the payment by responding with a text message payment instruction including a specified code. In this case the word “Pay” is the specified code but it may be any letter, word, number, combination of letters and/or words and/or numbers or other form as prescribed for the specific application. A user may reply to the received message with the word “Pay”. This sends a message from the recipient address 8 to the sending address 9 (711 in this case) with the message “Pay” to computer 1 via a text messaging system.

Computer 1 identifies the transaction based on the recipient address 8 and the sending address 9. The “Pay” message causes computer 1 to process the transaction and effect a transfer of funds from the customer's account to the payee's account. This processing may occur in real time, in batches or in any other desired manner. An acknowledgement message may then be sent to the recipient address acknowledging receipt of the payment instruction. Once the transaction is completed or the transaction expires the sending address (short code 711) used for the transaction may be returned to the pool of sending addresses 7 for that customer.

If all but one available short codes of a pool of short codes for a recipient address are in use a transaction identifier may be included in the text message payment request. A user may be required to include the transaction identifier (e.g. “ABC001”) and a specified code (e.g. “Pay”) in the text message payment instruction. The text message payment instruction may be correlated to a customer transaction if it includes a transaction identifier associated with the recipient address for the text message payment instruction. This allows transactions to be carried out even if the pool of short codes has been exhausted. One short code may be reserved for such transactions.

There is thus provided a method enabling payments to be authorized from a mobile phone using text messaging. Whilst the method has been described in relation to authorization of a payment it will be appreciated that the method allows ingoing and outgoing messages to be correlated for a number of applications. The reply message may be used to initiate an automated processing of a transaction or an automated action. Some examples include:
A ticket vendor sending a text message saying “U got 3 tickets to <some act> at last yr's Arts Festival. Text BOOK & the nmbr of tix 2 book for <some similar act> @ nxt yr's fest.”. If the recipient sends the message “BOOK 2” then two tickets may be automatically booked.
A record vendor has a profile for a user and sends a text message to the user saying: “<2nd hand CD details> now avail. Text YES if U want 2 reserve this now.” if a CD matches a user profile. If the user responds with “YES” then the CD will be reserved.
A stock broker may send a shareholder a text message advising them that “Telecom Shares have hit $10. You have 10,000 shares. Reply SELL to sell.”. If the shareholder responds with “SELL” then the stockbroker may automatically sell the shares.
A text message could be sent asking whether someone may access a recipient's premises and upon receipt of a “yes” message a security system may be activated to allow access.

While the present invention has been illustrated by the description of the embodiments thereof, and while the embodiments have been described in detail, it is not the intention of the Applicants to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicants' general inventive concept.

1. A method of authorisation of a payment comprising:
allocating one of a plurality of sending addresses to a transaction;
sending a text message payment request to a recipient address from the sending address;
receiving a text message payment instruction from the recipient address to the sending address;
correlating the text message payment instruction with the text message payment request based on the sending address and recipient address: and
processing the payment instruction.

2. A method as claimed in claim 1 wherein the sending address is a short code.

3. A method as claimed in claim 2 wherein the sending address is selected from a pool of short codes.

4. A method as claimed in claim 3 wherein a short code is removed from the pool associated with a recipient address when it is allocated to a transaction.

5. A method as claimed in claim 4 wherein a short code is returned to the pool when processing of a transaction is complete or the transaction expires.

6. A method as clamed in claim 3 wherein if only one short code is available from the pool a transaction identifier is included in the text message payment request

7. A method as claimed in claim 6 wherein the text message payment instruction is correlated to a transaction if it includes a transaction identifier associated with the recipient address for the text message payment instruction.

8. A method as claimed in claim 1 wherein the sending address is a long code.

9. A method as claimed in claim 1 wherein the sending address is a MSIDN number.

10. A method as claimed in claim 1 wherein a transaction is automatically processed based on the payment instruction.

11. A method as claimed in claim 6 wherein payments are processed in real time.

12. A method as claimed in claim 10 wherein payments are processed in batches.

13. A method as claimed in claim 10 wherein funds are transferred if the text message payment instruction includes a specified code.

14. A method as claimed in claim 13 wherein the specified code is a word.

15. A method as claimed in claim 13 wherein the specified code is a letter.

16. A method as claimed in claim 13 wherein the specified code is a number.

17. A method as claimed in claim 13 wherein the specified code is a combination of a number and/or letter and/or word.

18. A method as claimed in claim 13 wherein the text message payment instruction identifies the payee and the amount to be transferred.

19. A method as claimed in claim 13 wherein an acknowledgement message is sent to the recipient address confirming receipt of the text message payment instruction.

20. An automated online payment system comprising processing means for receiving payment requests, allocating a sending address to a payment request, sending the payment request in a text message to a recipient address from the sending address, receiving a text message payment instruction from the recipient address, reconciling the payment instruction with the payment request based on the sending address and the recipient address and processing the transaction based on the payment request and payment instruction.

21. A method of correlating text messages comprising:
allocating one of a plurality of sending addresses to an outgoing text message;
sending the outgoing text message to a recipient address from the sending address;
receiving an incoming text message from the recipient address to the sending address; and
correlating the outgoing and incoming text messages based on the sending address and recipient address.

22. A method as claimed in claim 21 wherein the sending address is a short code.

23. A method as claimed in claim 22 wherein the sending address is selected from a pool of short codes.

24. A method as claimed in claim 23 wherein a short code is removed from the pool associated with a recipient address when it is allocated to a transaction.

25. A method as claimed in claim 24 wherein a short code is returned to the pool when processing of a transaction is complete.

26. A method as claimed in claim 21 wherein an automated action is performed based upon a specified code contained in the incoming text message.

27. A method as claimed in claim 26 wherein the specified code is a word.

28. A method as claimed in claim 26 wherein the specified code is a letter.

29. A method as claimed in claim 26 wherein the specified code is a number.

30. A method as claimed in claim 26 wherein the specified code is a combination of one or more word and/or one or more letter and/or one or more number.
